(19) United States
(12) Patent Application Publication
(10) Pub. No.: US 2020/0013018 A1
(43) Pub. Date: Jan. 9, 2020

(54) Incident Documentation Systems and Methods

(71) Applicant: MINDU SYSTEM (Y.S.) LTD, Haifa (IL)

(72) Inventor: Sasson Yona Yamin, Haifa (IL)

(21) Appl. No.: 16/483,422

(22) PCT Filed: Jan. 11, 2018
(86) PCT No.: PCT/IB2018/050168

§ 371 Date: Aug. 4, 2019

Related U.S. Application Data
(60) Provisional application No. 62/454,821, filed on Feb. 5, 2017.

(51) Int. Cl. G06Q 10/10; G06F 16/93

(52) U.S. Cl. CPC G06Q 10/105; G06F 16/93

(57) ABSTRACT

A method comprising: (a) recording details of an alleged infraction, including the identity of an accused wrongdoer, in a digital format; and (b) concurrently transmitting said details to said accused wrongdoer and to an infraction database. Also disclosed is a system comprising: (a) a database designed and configured to receive and store complaints of alleged infractions by specific individuals belonging to an institution; and (b) an education module designed and configured to push educational materials to said specific individuals that are the subject of said complaints.

### RELATED APPLICATIONS

This application claims the benefit under 35 U.S.C. § 119(e) of provisional application 62/454,821 filed 5 Feb. 2017 and having the same title and inventor as the present application; which is fully incorporated herein by reference.

### FIELD OF THE INVENTION

The invention is in the field of databases and/or event recordation.

### BACKGROUND OF THE INVENTION

Bullying is the abuse, intimidation, or aggressive domination of others by force, threat, or coercion. Bullying is distinguished from conflict by the perception [by the bully or by others] of an imbalance of social or physical power. Bullying behaviors include verbal harassment, threat, physical assault, and coercion. These acts are often directed repeatedly towards particular targets.

Rationalizations for bullying include differences of social class, race, religion, gender, sexual orientation, appearance, behavior, body language, personality, reputation, lineage, strength, size or ability. There is no universally accepted legal definition of bullying.

Mobbing refers to bullying is done by a group. Peer abuse is a term sometimes applied to bullying in school or the workplace.

Sexual harassment is bullying or coercion of a sexual nature. Sexual harassment includes the unwelcome or inappropriate promise of rewards in exchange for sexual favors. In most modern legal contexts, sexual harassment is illegal.

As defined by the US Equal Employment Opportunity Commission (EEOC), “It is unlawful to harass a person (an applicant or employee) because of that person's sex.” Harassment can include “sexual harassment” or unwelcome sexual advances, requests for sexual favors, and other verbal or physical harassment of a sexual nature. Sexual harassment is subject to a directive in the European Union. The exact legal definition of sexual harassment varies widely according to jurisdiction.

In its broadest sense, sexual harassment involves a range of behaviors. In many cases it is difficult for the victim to describe what they experienced. This difficulty can be related to difficulty classifying the situation or can be related to the trauma of the incident.

Two main classes of harassers are reported in the literature:

Public harassers are openly seductive or sexist towards colleagues and/or subordinates while private harassers maintain a respectable image in public, but exhibit a different demeanor in private.

There is also a theoretical “general civility code” which would forbid simple teasing, offhand comments, or minor isolated incidents.

### SUMMARY OF THE INVENTION

A broad aspect of some embodiments of the invention relates to improving behavior in an institution. For purposes of this specification and the accompanying claims, the term “institution” is to be interpreted in its broadest possible meaning. Institution therefore includes, but is not limited to, a company, a school, a university, a governmental office, a military unit, an NGO, a public utility, a family cell, a community. a team, a religious administration, (e.g. diocese or parish) and a social organization. Social organizations include, but are not limited to Scout troops, 4H clubs, fraternal orders (e.g. Masons, Deaks, Elks, or “Greek” college fraternities), Alumni organizations, Veterans of Foreign Wars (VFW) posts, Kiwanis clubs and Rotary clubs.

According to one aspect of some embodiments of the invention an institution distributes an application with a user interface (UI) that facilitates documentation of an alleged infraction by a person that “belongs” to the institution. The nature of “belonging” varies according to the nature of the institution. Employees of an institution clearly belong to that institution. For some institution types, additional classes of people may also “belong” to the institution. For example, as a school or university, students also belong to the institution. In some embodiments the UI is graphical (GUI). In some embodiments, use of a GUI contributes to simplification of the documentation process and/or to simplification of report generation. In some embodiments the institution controls who can download and use the application.

In another aspect of some embodiments of the invention, a complainant documents an alleged infraction by concurrently transmitting a report of an alleged infraction to the accused wrongdoer and to a complaints database maintained by the institution and/or by an external service provider. In some embodiments the complainant uses a UI containing a complaint template. According to various exemplary embodiments of the invention, the template has three, four, five or more complaint categories. In some exemplary embodiments of the invention, the categories cover a range of infraction severity. In some embodiments the transmission is encrypted. Alternatively or additionally, in some embodiments the storage is encrypted.

One aspect of some embodiments of the invention relates to a system for institutional oversight, which maintains a database of complaints of alleged infractions. In some embodiments the database sorts complaints by sub-units within the institution (e.g. departments). According to various exemplary embodiments of the invention departmental sorting is by accused wrongdoer and/or by complainant. Alternatively or additionally, in some embodiments the database generates reports on individuals that are the accused wrongdoer in two or more alleged infractions. Alternatively or additionally, in some embodiments the database pushes relevant educational material to accused wrongdoers. In some embodiments, a report generated by the database indicates the number of individual sources of complaints and/or the identities of the complainants.

One aspect of some embodiments of the invention relates to a system for behavioral correction in which the database is designed and configured to automatically push relevant educational materials to accused wrongdoers and/or to automatically invite accused wrongdoers to institutional disciplinary procedures.

One aspect of some embodiments of the invention relates to a system for generation of legal evidence. According to these embodiments, if a complainant has made a series of complaints against a single accused wrongdoer, the complainant can request that the database generate an evidentiary list suitable for use in a legal proceeding outside the institution.

It will be appreciated that the various aspects described above relate to solution of technical problems associated with documentation of various types of bullying and harassment.

Alternatively or additionally, it will be appreciated that the various aspects described above relate to solution of technical problems related to automation of the institution's efforts to address various types of bullying and harassment within the institution.

In some exemplary embodiments of the invention there is provided a method including: (a) recording details of an alleged infraction, including the identity of an accused wrongdoer, in a digital format; and (b) concurrently transmitting the details to the accused wrongdoer and to an infraction database. In some embodiments the method includes appending a digital signature to the details. Alternatively or additionally, in some embodiments the method includes attaching at least one member of the group consisting of one or more image files, one or more audio files, one or more video files and one or more files of another type to the details. Alternatively or additionally, in some embodiments the recording employs a user interface (UI) containing a complaint template. Alternatively or additionally, in some embodiments the method includes encrypting the details during the transmitting. Alternatively or additionally, in some embodiments the method includes storing the details in an encrypted form in the infraction database. Alternatively or additionally, in some embodiments the method includes receiving a response to the details of the alleged infraction from the accused wrongdoer, the response concurrently transmitted to the infraction database.

In some exemplary embodiments of the invention there is provided a system including: (a) a database designed and configured to receive and store complaints of alleged infractions by people belonging to an institution; and (b) a report generator designed and configured to periodically generate reports of the alleged infractions. In some embodiments the report generator sorts complaints by sub-units within the institution. Alternatively or additionally, in some embodiments the system includes a problem individual identifier designed and configured to generate a report on any individual that is the subject of more than a specified number of the complaints. Alternatively or additionally, in some embodiments the system includes an education module configured to push relevant educational material to people that are the subject of one or more complaints. Alternatively or additionally, in some embodiments the system includes a sensitive individual identifier designed and configured to generate a report on any individual that is the source of more than a specified number of the complaints.

In some exemplary embodiments of the invention there is provided a system including: (a) a database designed and configured to receive and store complaints of alleged infractions by specific individuals belonging to an institution; and (b) an education module designed and configured to push educational materials to the specific individuals that are the subject of the complaints. In some embodiments the system includes a discipline module designed and configured to automatically invite the specific individuals that are the subject of the complaints to institutional disciplinary procedures. Alternatively or additionally, in some embodiments the system includes a report generator designed and configured to issue reports of the educational materials pushed to the specific individuals.

In some exemplary embodiments of the invention there is provided a system including: (a) a database designed and configured to receive and store complaints of alleged infractions by people belonging to an institution; and (b) an evidence generator designed and configured to respond to a request from a first individual by providing a list of complaints submitted by the first individual formatted for submission as legal evidence. In some embodiments the request indicates a second individual and the list includes only those complaints in which the second individual is named. Alternatively or additionally, in some embodiments the request indicates a second individual and the list includes responses from the second individual to individual complaints. Alternatively or additionally, in some embodiments the evidence generator is designed and configured to apply a digital signature to the list.

In some exemplary embodiments of the invention there is provided a user interface (UI) including: (a) a time/date definition module; (b) a location definition module; (c) an interaction type definition module; and (d) an event type definition module. In some embodiments the UI includes an additional witnesses module. Alternatively or additionally, in some embodiments the UI includes a free text field for entry of a description of the event. Alternatively or additionally, in some embodiments the interaction type definition module is provided as a menu. Alternatively or additionally, in some embodiments the event type definition module is provided as a menu. Alternatively or additionally, in some embodiments the UI includes a browse button to select one or more files for upload as attachments.

In some exemplary embodiments of the invention there is provided a system including: (a) a database designed and configured to receive and store complaints of alleged infractions by accused wrongdoers; and (b) an evidence generator designed and configured to respond to a request from one of the accused wrongdoers by providing a list of complaints submitted against one of the accused wrongdoers by a single individual, together with responses to those complaints submitted by the one of the accused wrongdoers formatted for submission as legal evidence. In some embodiments the evidence generator is designed and configured to apply a digital signature to the list.

Unless otherwise defined, all technical and scientific terms used herein have the same meaning as commonly understood by one of ordinary skill in the art to which this invention belongs. Although suitable methods and materials are described below, methods and materials similar or equivalent to those described herein can be used in the practice of the present invention. In case of conflict, the patent specification, including definitions, will control. All materials, methods, and examples are illustrative only and are not intended to be limiting.

As used herein, the terms “comprising” and “including” or grammatical variants thereof are to be taken as specifying inclusion of the stated features, integers, actions or components without precluding the addition of one or more additional features, integers, actions, components or groups thereof. This term is broader than, and includes the terms “consisting of” and “consisting essentially of” as defined by the Manual of Patent Examination Procedure of the United States Patent and Trademark Office. Thus, any recitation that an embodiment “includes” or “comprises” a feature is a specific statement that sub embodiments “consist essentially of” and/or “consist of” the recited feature.

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

The phrase “adapted to” as used in this specification and the accompanying claims imposes additional structural limitations on a previously recited component.

The term “method” refers to manners, means, techniques and procedures for accomplishing a given task including, but not limited to, those manners, means, techniques and procedures either known to, or readily developed from known manners, means, techniques and procedures by practitioners of architecture and/or computer science.

Implementation of the method and system according to embodiments of the invention involves performing or completing selected tasks or steps manually, automatically, or a combination thereof. Moreover, according to actual instrumentation and equipment of exemplary embodiments of methods, apparatus and systems of the invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### BRIEF DESCRIPTION OF THE DRAWINGS

In order to understand the invention and to see how it may be carried out in practice, embodiments will now be described, by way of non-limiting example only, with reference to the accompanying figures. In the figures, identical and similar structures, elements or parts thereof that appear in more than one figure are generally labeled with the same or similar references in the figures in which they appear. Dimensions of components and features shown in the figures are chosen primarily for convenience and clarity of presentation and are not necessarily to scale. The attached figures are:

FIG. 1 is a schematic system overview of an operational context of various exemplary embodiments of the invention;

FIG. 2 is a simplified flow diagram of a method according to some exemplary embodiments of the invention;

FIG. 3a is a schematic representation of a system according to some exemplary embodiments of the invention;

FIG. 3b is a simulated screen shot of a report according to some exemplary embodiments of the invention;

FIG. 3c is a simulated screen shot of a report according to some exemplary embodiments of the invention;

FIG. 4a is a schematic representation of a system according to some exemplary embodiments of the invention;

FIG. 4b is a simulated screen shot of a report according to some exemplary embodiments of the invention;

FIG. 5 is a schematic representation of a system according to some exemplary embodiments of the invention;

FIG. 6 is a simulated screen shot of a user interface (UI) according to some exemplary embodiments of the invention; and

FIG. 7 a schematic representation of a system according to some exemplary embodiments of the invention.

### DETAILED DESCRIPTION OF EMBODIMENTS

Embodiments of the invention relate to systems and methods and user interfaces for event recordation and/or documentation and/or monitoring and/or response.

Specifically, some embodiments of the invention are used to record and/or document various types of harassing behavior within an institution and/or organization.

The principles and operation of a system and/or method and/or user interface according to exemplary embodiments of the invention may be better understood with reference to the drawings and accompanying descriptions.

Before explaining at least one embodiment of the invention in detail, it is to be understood that the invention is not limited in its application to the details set forth in the following description or exemplified by the Examples. The invention is capable of other embodiments or of being practiced or carried out in various ways. In addition, the phraseology and terminology employed herein is for the purpose of description and should not be regarded as limiting.

Exemplary System Overview

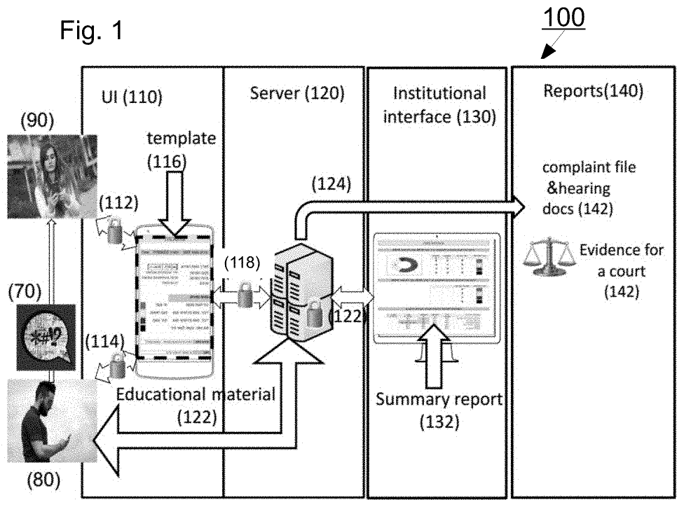

FIG. 1 is a schematic system overview of an operational context, indicated generally as system 100, according to various exemplary embodiments of the invention,

Depicted exemplary system 100 provides complementary functions to people that belong to an institution as well as to the institution itself.

In the depicted embodiment, a server 120 provides people (e.g. 80 and 90) with an application that presents a user interface (UI) 110 for complaints concerning alleged infractions of behavioral policy. Although only two people (80 and 90) are depicted for clarity, a much larger number of people from a single institution typically download and install the application and have access to UI 110.

Server 120 is described here in the context of a single institution for clarity, although a single server provides application downloads and related services to multiple institutions in many embodiments of the invention. In some embodiments people (e.g. 80 and 90) download an application that is specific to an institution that they belong to. Alternatively or additionally, in some embodiments a single person downloads and installs multiple applications corresponding to multiple institutions. For example, in some embodiments person 80 downloads one application provided by their employer ABC company, another application belonging to their local VFW post and a third application belonging to a college where they are registered as a student.

Each application downloaded provides a UI 110 with a template 116 that is specific to the relevant institution. Template 116 is designed to record complaints and/or responses to complaints. According to various exemplary embodiments of the invention, the application is installed on a smartphone and/or phablet and/or tablet and/or laptop computer and/or desktop computer. In some embodiments, use of a handheld device (e.g. smartphone) contributes to an increase in efficiency of event recordation.

As an example of how system 100 is used, person 80 says, or does, something 70, which another person 90 belonging to the same institution feels is an infraction of accepted behavioral policy. Person 90 assumes the role of complainant and, using template 116 in UI 110 of the application records 112 details of incident 70 including the identity of person 80, who is defined as an accused wrongdoer. The complaint recorded by person 90 is optionally encrypted and sent concurrently to server 120 and accused wrongdoer 80 by the application on user 90's device (e.g. smartphone). The concurrent transmissions are depicted as 118 and 114 respectively. In the depicted embodiment, details of event 70 are stored on server 120 in encrypted form.

Accused wrongdoer 80 has an opportunity to respond the complaint of alleged infraction 70 via UI 110 and/or template 116 on their device. Responses are concurrently transmitted to complainant 90 and server 120 as 112 and 118 respectively. In some embodiments, accused wrongdoer 80 sees the identity of accuser 90 in received complaint 114.

In some embodiments recordation of alleged infraction 70 at server 120 triggers automatic transmission relevant educational material to alleged wrongdoer 80 by server 120. In some embodiments relevancy of specific education material items is determined by server 120 according to the items selected in template 116 by complainant 90. In some embodiments, use of template 116 contributes to an increase in relevancy of educational material 122 to alleged infraction 70. According to various exemplary embodiments of the invention, the educational material 122 includes text and/or graphics and/or audio content and/or video content.

In the depicted embodiment, server 120 also provides 122 summary reports 132 to institutional personnel via institutional interface 130. In some embodiments, the summary reports do not include the identity of complainant 90 and/or accused wrongdoer 80.

Alternatively or additionally, in some embodiments complainant 90 requests, via UI 110 that server 120 issue 124 reports 140. According to various exemplary embodiments of the invention reports 140 are format as a complaint file and hearing documents 142 for use within the institution and/or as evidence 142 for a court. Various features of different embodiments of the invention are described in greater detail hereinbelow with periodic reference to this overview. For example, databases 310 and/or 410, and/or 510 and/or 710 as described hereinbelow reside on server 120 in some embodiments of the invention.

Exemplary Method of Registering Alleged Infractions

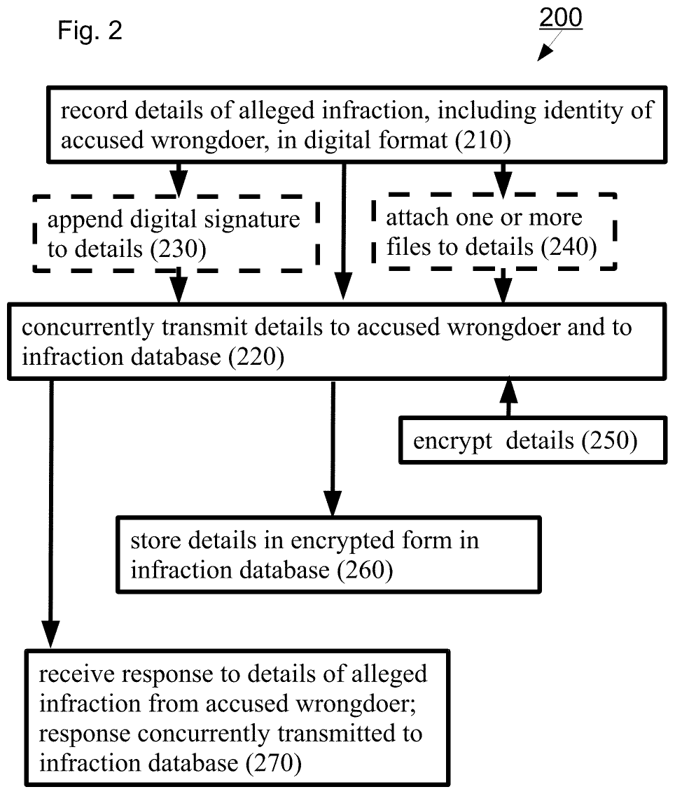

FIG. 2 is a simplified flow diagram, indicated generally as 200, of a method for registration of alleged infractions according to some exemplary embodiments of the invention.

Depicted exemplary method 200 includes recording 210 details of an alleged infraction (e.g. 70 in FIG. 1) including the identity of an accused wrongdoer (e.g. 80 in FIG. 1), in a digital format and concurrently transmitting 220 the details to the accused wrongdoer and to an infraction database (e.g. residing on server 120 in FIG. 1. Alternatively or additionally, in some embodiments method 200 includes appending 230 a digital signature to the details. Alternatively or additionally, in some embodiments Method 200 includes attaching 240 one or more image files and/or one or more audio files and/or one or more video files and /or one or more files of another type to the details. According to various exemplary embodiments of the invention recording 210 is done using a smartphone, phablet, tablet, laptop computer or desktop computer.

In some embodiments recording 210 employs a user interface (UI) containing a complaint template (e.g. 110/116 in FIG. 1). In some embodiments, the template has three, four, five or more complaint categories. In some exemplary embodiments of the invention, the categories cover a range of infraction severity. In some embodiments, use of categories contributes to efficiency in report generation.

Alternatively or additionally, in some embodiments method 200 includes encrypting 250 details during said transmitting. Alternatively or additionally, in some embodiments method 200 includes storing the details in an encrypted form in the infraction database. In some embodiments, the transmission(s) 220 is/are end to end encrypted. According to various exemplary embodiments of the invention, encryption employs public keys and/or private keys.

Alternatively or additionally, in some embodiments method 200 includes receiving 270 a response to the details of the alleged infraction from the accused wrongdoer in the user interface of the application used to record the details. In some embodiments, the response includes an alternate set of details. In some embodiments, the response is concurrently transmitted to the infraction database.

Exemplary System for Institutional Oversight

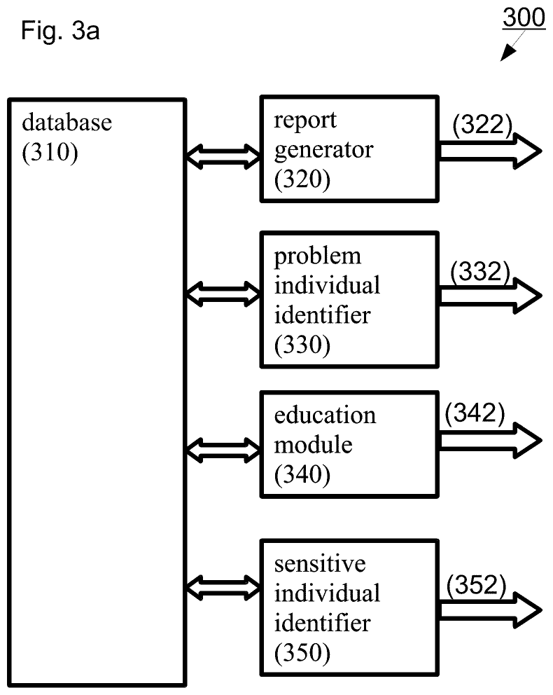

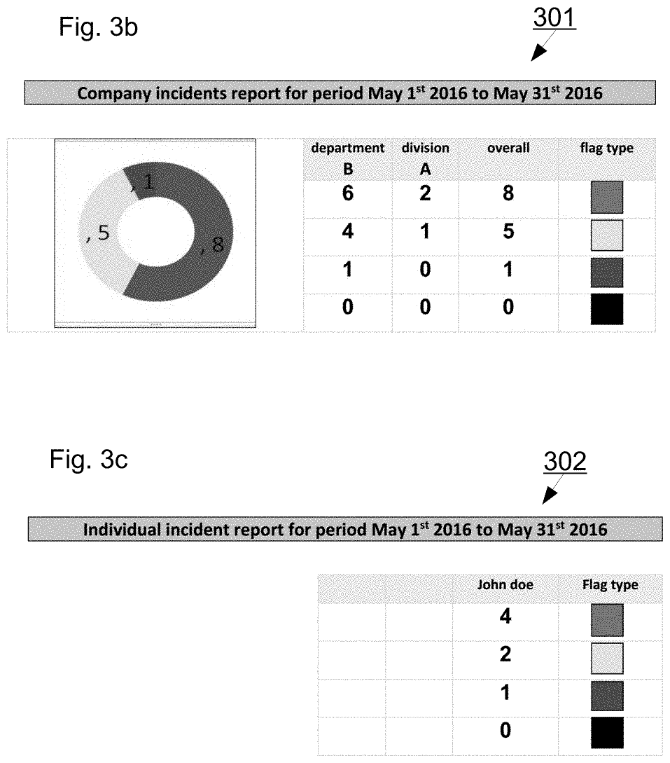

FIG. 3a is a schematic representation of a system for institutional oversight of behavior within the institution, indicated generally as 300, according to some exemplary embodiments of the invention.

In the depicted embodiment, system 300 includes a database 310 designed and configured to receive and store complaints of alleged infractions by people belonging to an institution.

In some embodiments system 300 includes a report generator 320 designed and configured to periodically generate reports 322 of the alleged infractions. In some embodiments, an algorithm recommends to responsible personnel at the appropriate action to take against specific individuals on the basis of these reports. In some embodiments, report generator 320 sorts complaints by sub-units within the institution.

FIG. 3b is a simulated report, indicated generally as 301, depicting complaints sorted by sub-units within the institution.

According to various exemplary embodiments of the invention, report 322 specifies within each subunit how may accused wrongdoers are identified in the complaints and/or how many complainants are responsible for the complaints. In some embodiments, report 322 generated by the database indicates the identities of the complainants and/or the identities of the accused wrongdoers.

In some embodiments system 300 includes a problem individual identifier 330 designed and configured to generate a report 332 on any individual that is the subject (i.e. is the accused wrongdoer) of more than a specified number of said complaints. In some embodiments, report 332 is generated as soon as a threshold number of complaints identifying a same accused wrongdoer is reached. According to various exemplary embodiments of the invention the threshold number of complaints is one, two, three, four or more. According to various exemplary embodiments of the invention, the threshold number varies inversely with the severity of complaint type.

FIG. 3c is a simulated report on a problem individual, indicated generally as 302, depicting complaints against one individual sorted by event type.

In some embodiments system 300 includes an education module 340 designed and configured to push relevant educational material 342 to people that are the subject of one or more complaints. According to various exemplary embodiments of the invention, educational material 342 is delivered to the accused wrongdoer via UI 110 of the complaint registration application and/or via e-mail.

In some embodiments system 300 includes a sensitive individual identifier 350 designed and configured to generate a report 352 on any individual that is the source of more than a specified number of complaints. In some embodiments, report 352 is generated as soon as a threshold number of complaints by a same individual is reached. According to various exemplary embodiments of the invention the threshold number of complaints is one, two, three, four or more. According to various exemplary embodiments of the invention, the threshold number varies inversely with the severity of complaint type.

Exemplary Behavioral Correction System.

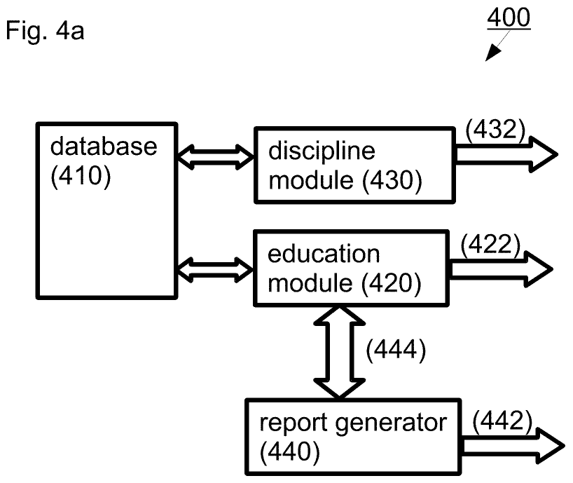

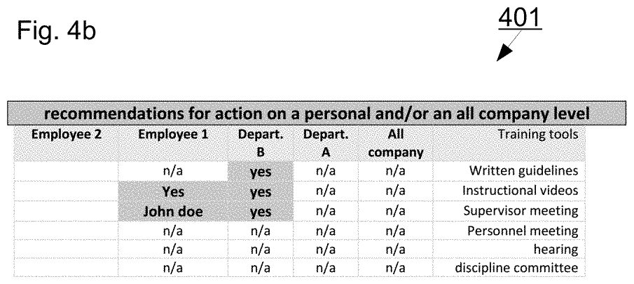

FIG. 4a is a schematic representation of a system for behavioral correction, indicated generally as 400 according to some exemplary embodiments of the invention.

Depicted exemplary system 400 includes a database 410 designed and configured to receive and store complaints of alleged infractions by specific individuals belonging to an institution. In the depicted embodiment, system 400 includes an education module 420 designed and configured to push educational materials 422 to specific individuals that are the subject of the complaints. In some embodiments, implementation of module 420 contributes to efficiency of operation of institutional human resources (HR) systems by reducing a need for periodic training of all people within the institution.

In some embodiments system 400 includes a discipline module 430 designed and configured to automatically invite 432 the specific individuals that are the subject of the complaints to institutional disciplinary procedures. According to various exemplary embodiments of the invention invitations 432 are issued via e-mail and/or text message (SMS) and/or instant messaging and/or via UI 110 of the complaint registration application.

Alternatively or additionally, in some embodiments system 400 includes a report generator 440 designed and configured to issue reports 442 of the educational materials 422 pushed to the specific individuals. In the depicted embodiment, report generator 440 monitors 444 activity of module 420 and issues reports 442 periodically and/or in response to requests received from authorized personnel within the institution and/or when predefined thresholds are met. According to various exemplary embodiments of the invention, reports 442 are sorted by individual and/or time and/or topic and/or institutional subunit.

FIG. 4b is a simulated report, indicated generally as 401. Indicating that an instructional video was sent to employee 1 and that employee 1 has been invited to a meeting with their supervisor to discuss the complaints registered against them.

In some embodiments, a report 442 pertaining to specific accused wrongdoer (e.g. 80 in FIG. 1) that is the subject of numerous complaints over a period of time serves as evidence in a relevant institutional disciplinary proceeding. Alternatively or additionally, report 442 contributes to a reduction in institutional liability in a legal proceeding outside the institution. In some exemplary embodiments of the invention, report 442 includes a recommendation to the institutions' responsible person. According to various exemplary embodiments of the invention the recommendation includes what action to take and/or against whom to take action and /or what educational material to use. According to these embodiments, a responsible person at the institution decides if and/or how to implement the recommendation. Alternatively or additionally, in some embodiments the recommendation leads to push of educational materials 122 (FIG. 1) by server 120 to one or more specific people (e.g. 80 in FIG. 1).

Exemplary Evidence Generation System

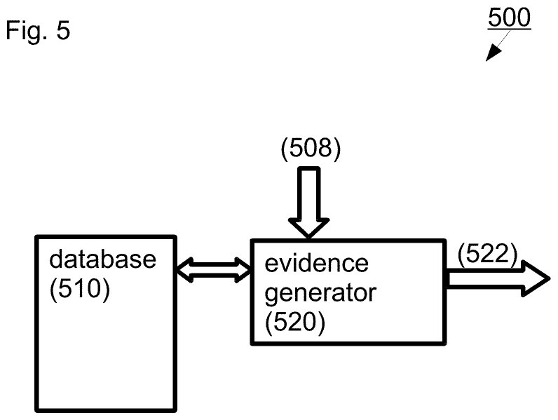

FIG. 5 is a schematic representation of a system for evidence generation, indicated generally as 500, according to some exemplary embodiments of the invention.

Depicted exemplary system 500 includes a database 510 designed and configured to receive and store complaints of alleged infractions by people belonging to an institution. In the depicted embodiment, system 500 includes an evidence generator 520 designed and configured to respond to a request 508 from a first individual (e.g. 90 in FIG. 1) by providing a list 522 of complaints submitted by the first individual formatted for submission as legal evidence. In some embodiments each complaint in the list bears a time/date stamp appended by the system when the complaint was received.

In some embodiments request 508 indicates a second individual (e.g. 80 in FIG. 1) and list 522 includes only those complaints in which said second individual is named.

In some embodiments request 508 indicates a second individual (e.g. 80 in FIG. 1) and list 522 includes responses from the second individual to individual complaints in list 522. Alternatively or additionally, in some embodiments evidence generator 520 applies a digital signature to list 522.

Exemplary Complaint Recordation User Interface

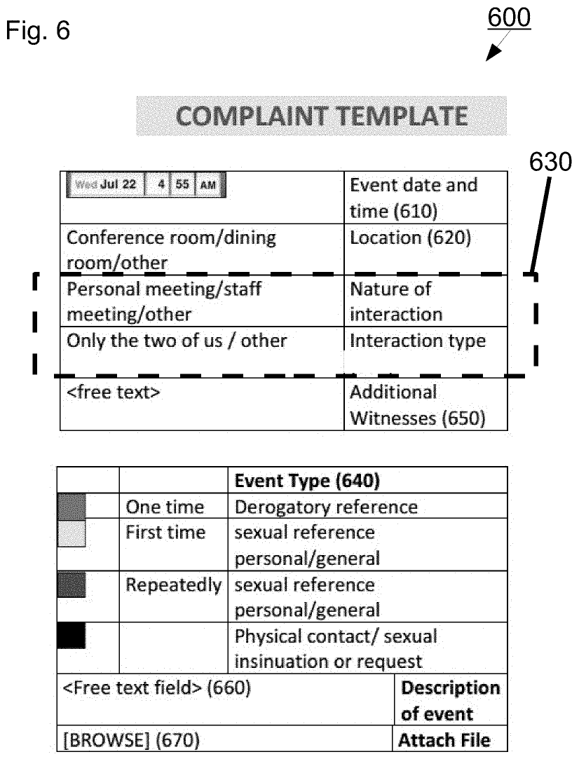

FIG. 6 is a simulated screen shot of a user interface (UI) for complaint recordation, indicated generally as 600 according to some exemplary embodiments of the invention. UI 600 is one possible design for template 116 in FIG. 1.

In the depicted embodiment, UI 600 is used to define particulars of an incident (e.g. 70 in FIG. 1) after an accused wrongdoer (e.g. 80 in FIG. 1) has been indicated on a previous screen.

Depicted exemplary UI 600 includes a time/date definition module 610. According to various exemplary embodiments of the invention time and ate are entered either manually and/or via scroll wheels and/or a calendar interface.

Depicted exemplary UI 600 includes a location definition module 620. In the depicted embodiment, module 620 is a menu that includes locations specific to the institution providing the application. Alternatively or additionally, location is entered as free text.

Depicted exemplary UI 600 includes an interaction type definition module 630. In the depicted embodiment, module 630 provides for separate entry of nature of interaction and interaction type. According to various exemplary embodiments of the invention, either or both of these fields are menu based and/or free text capable.

Depicted exemplary UI 600 includes an event type definition module 640. Depicted exemplary module 640 includes a menu that characterizes events in increasing order of severity. Although four categories are listed, smaller or larger numbers of categories are present in various exemplary embodiments of the invention.

Depicted exemplary UI 600 includes an additional witnesses module. In the depicted embodiment, module 650 is provided as a free text field. In other exemplary embodiments of the invention, module 650 is menu based.

Depicted exemplary UI 600 includes a free text field 660 for entry of a description of the event. In some embodiments, the accused wrongdoer is invited to respond to this description.

In some embodiments, interaction type definition module 630 is provided as a menu.

In some embodiments, event type definition module 640 is provided as a menu.

Depicted exemplary UI 600 includes a browse button 670 to select one or more files for upload as attachments.

Additional Exemplary Evidence Generation System

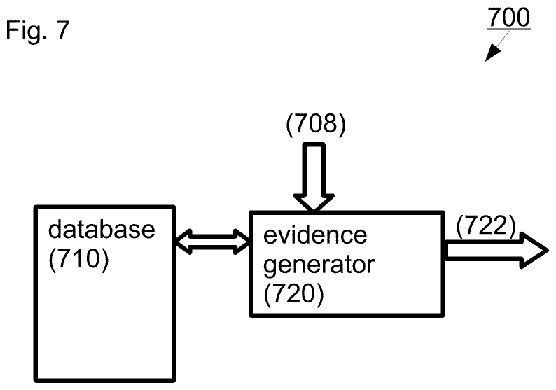

FIG. 7 a schematic representation of a system for generation of defense evidence, indicated generally as 700, according to some exemplary embodiments of the invention.

Depicted exemplary system 700 includes a system comprising a database 710 designed and configured to receive and store complaints of alleged infractions by accused wrongdoers. Depicted exemplary system 700 also includes an evidence generator 720 designed and configured to respond to a request 708 from one of the accused wrongdoers by providing a list of complaints submitted against that one of the accused wrongdoers by a single individual, together with responses to those complaints submitted by that one of the accused wrongdoers formatted for submission as legal evidence. Alternatively or additionally, in some embodiments evidence generator 720 applies a digital signature to list 722.

Exemplary Encryption Considerations

According to various exemplary embodiments data transmissions 112 and/or 114 and/or 118 are protected with an end-to -end encryption protocol so that third parties cannot read them and so that the messages can only be decrypted by the recipient and/or sender. In some embodiments this encryption appliers also to any attached files.

Exemplary Digital Signature Considerations

In some exemplary embodiments of the invention, server 120 applies a digital signature to output 124. Alternatively or additionally, in some embodiments users (e.g. 90 and/or 80) apply a digital signature, for example to evidence 142 prior to submission to a court.

It is expected that during the life of this patent many encryption protocols will be developed and the scope of the invention is intended to include all such new technologies a priori.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

Specifically, a variety of numerical indicators have been utilized. It should be understood that these numerical indicators could vary even further based upon a variety of engineering principles, materials, intended use and designs incorporated into the various embodiments of the invention. Additionally, components and/or actions ascribed to exemplary embodiments of the invention and depicted as a single unit may be divided into subunits. Conversely, components and/or actions ascribed to exemplary embodiments of the invention and depicted as sub-units/individual actions may be combined into a single unit/action with the described/depicted function.

Alternatively, or additionally, features used to describe a method can be used to characterize an apparatus and features used to describe an apparatus can be used to characterize a method.

It should be further understood that the individual features described hereinabove can be combined in all possible combinations and sub-combinations to produce additional embodiments of the invention. The examples given above are exemplary in nature and are not intended to limit the scope of the invention which is defined solely by the following claims.

Each recitation of an embodiment of the invention that includes a specific feature, part, component, module or process is an explicit statement that additional embodiments of the invention not including the recited feature, part, component, module or process exist.

Alternatively or additionally, various exemplary embodiments of the invention exclude any specific feature, part, component, module, process or element which is not specifically disclosed herein.

Specifically, the invention has been described in the context of harassment but might also be used to monitor any type of offline interaction.

All publications, references, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

The terms “include”, and “have” and their conjugates as used herein mean “including but not necessarily limited to”.

1. A method comprising:
(a) recording details of an alleged infraction, including the identity of an accused wrongdoer, in a digital format; and
(b) concurrently transmitting said details to said accused wrongdoer and to an infraction database.

2. A method according to claim 1, comprising appending a digital signature to said details.

3. A method according to claim 1, comprising attaching at least one member of the group consisting of one or more image files, one or more audio files, one or more video files and one or more files of another type to said details.

4. A method according to claim 1, wherein said recording employs a user interface (UI) containing a complaint template.

5. A method according to claim 1, comprising encrypting said details during said transmitting.

6. A method according to claim 1, comprising storing said details in an encrypted form in said infraction database.

7. A method according to claim 1, comprising receiving a response to said details of said alleged infraction from said accused wrongdoer, said response concurrently transmitted to said infraction database.

8. A system comprising:
(a) a database designed and configured to receive and store complaints of alleged infractions by people belonging to an institution; and
(b) a report generator designed and configured to periodically generate reports of said alleged infractions.

9. A system according to claim 8, wherein said report generator sorts complaints by sub-units within the institution.

10. A system according to claim 8, comprising a problem individual identifier designed and configured to generate a report on any individual that is the subject of more than a specified number of said complaints.

11. A system according to claim 8, comprising an education module configured to push relevant educational material to people that are the subject of one or more complaints.

12. A system according to claim 8, comprising a sensitive individual identifier designed and configured to generate a report on any individual that is the source of more than a specified number of said complaints.

13-19. (canceled)

20. A user interface (UI) comprising:
(a) a time/date definition module;
(b) a location definition module;
(c) an interaction type definition module; and
(d) an event type definition module.

21. A UI according to claim 20, comprising: an additional witnesses module.

22. A UI according to claim 20 21, comprising: a free text field for entry of a description of the event.

23. A UI according to claim 20, wherein said interaction type definition module is provided as a menu.

24. A UI according to claim 20, wherein said event type definition module is provided as a menu.

25. A UI according to claim 20, comprising: a browse button to select one or more files for upload as attachments.

26-27. (canceled)
